(19) United States
(12) Patent Application Publication
(10) Pub. No.: US 2013/0229098 A1
(43) Pub. Date: Sep. 5, 2013

(54) Modular Rapid Access Illuminated Drawer Safe With Dual Access Methods

(71) Applicant: Adam Quinn Pletcher, Genoa City, WI (US)

(72) Inventor: Adam Quinn Pletcher, Genoa City, WI (US)

(21) Appl. No.: 13/411,882

(22) Filed: Mar. 5, 2012

(51) Int. Cl. E05G 1/04; A47B 81/00; E05B 65/46

(52) U.S. Cl. CPC E05G 1/04; E05B 65/46; A47B 81/00
USPC 312/237; 312/333; 70/86

(57) ABSTRACT

A modular drawer safe possessing upper indentions and lower protrusions allowing multiple units in varying sizes to be secured together. The drawer safe uses biometric recognition for its primary locking control and a manual keyed back-up. A multicolored illumination ring situated around the fingerprint reader provides low-level light as a visual point of reference and changes to green light when an authorized fingerprint is scanned or red light if an unauthorized or misread fingerprint is scanned. The drawer opens under its own spring or pneumatically driven motive force. Supplemental illumination within the drawer compartment consist of multiple pairs of red low-level illumination and brighter white illumination. All electrical components are powered by line voltage with an integral battery backup. AC power can be daisy-chained between multiple units thus only requiring a single receptacle to provide power to all components.

### CROSS-REFERENCE TO RELATED APPLICATIONS

Non-provisional filing for Provisional Application No. 61/449,636 filed Mar. 5, 2011

### STATEMENT REGARDING FEDERALLY SPONSORED RESEARCH OR DEVELOPMENT

N/A

### REFERENCE TO SEQUENCE LISTING, A TABLE, OR A COMPUTER PROGRAM LISTING COMPACT DISK APPENDIX

N/A

### BACKGROUND OF THE INVENTION

(1) Field of the Present Invention

The present invention pertains to a safe.

More particularly, the invention is a modular drawer safe allowing the user to safely store varying sizes or loaded ready-to-use firearms or other valuables in a secure manner while maintaining the ability to access said items in a quick and easy manner.

In a further respect, the present invention pertains to a modular drawer safe designed to be located near a homeowner in the bedroom while offering self-illumination points for convenient and easy access both during the day while also being able to be used and located without the need for ambient lighting.

In another respect, the invention pertains to a modular drawer safe using a biometric reader linked to the locking mechanism and an automatically opening drawer compartment that can be easily opened at times of high duress to gain access to the loaded, ready-to-use firearm when most needed.

In a further respect, the invention pertains to a modular drawer safe designed in a modular fashion, thereby allowing multiple units to be secured to each other to securely store firearms and valuables of various sizes, all while maintaining the ability of being accessed quickly.

(2) Description of the Prior Art

Secure storage devices, commonly known as safes, are well known. A safe is used to store firearms as well as items of value, such as jewelry, money and/or precious metals. The type of items desired for secure storage most often dictates the size, durability and design of the safe used. The most common design of a conventional safe of a square or vertically rectangular shape and composed of a metal or other durable material. They are typically bulky, heavy and of extremely sturdy construction.

Regarding the size and weight of a conventional safe, the smaller safes used to store smaller valuables and hand guns are typically not comparatively heavy. If unsecured, an intruder or unauthorized individual can easily steal the safe from the home or business premises.

Accordingly, it would be highly desired to provide an improved system and method for securing a safe. The implementation of a securing method to a building structure reduces the ability of the removal of the safe by unauthorized individuals.

Regarding the methods of securing content implemented by conventional safes, most rely on a key or number combination as the means of access. These methods, while offering moderate security, do not permit rapid access. Further, during a sudden home break-in or business robbery, the emotional duress experienced by the home or business owner can severely diminish his or her ability to find and use a key or remember a key combination. When a safe is used to store a firearm by a home or business owner for personal protection, the lack of immediate accessibility can have dangerous and life-threatening consequences.

Accordingly, it would be highly desirable to provide an improved method and apparatus for safely storing a loaded ready-to-use firearm. The implementation of a biometric locking mechanism preserves the security function of the safe while allowing the home or business owner immediate access with minimal motor skills and no cognitive memory requirements to gain access.

Further regarding conventional safes used to store firearms, home and business owners often own multiple firearms of varying sizes and uses. These can range from the small pocket-sized handgun up to long guns exceeding four feet in length. Conventional handgun safes, by their design, are sized to only hold and secure small items of value or handguns. Larger safes can accommodate a greater variety but the interior design is not conducive to quickly retrieving the desired handgun or long gun.

Accordingly, it would be highly desirable to provide an improved method and apparatus for storing any variety of handguns, long guns or items of value. The implementation of a modular drawer safe storage system would allow the home or business owner the ability to own properly sized safes for each intended purpose and maintain the ability to stack and secure such safes in a modular manner.

Further regarding the accessibility of a conventional safe, it lacks external self-illumination points to ensure access in low-light or no-light conditions. When used for home or business protection, if no light source is present or adequate, a home or business owner loses the ability to quickly locate the safe for access. As mentioned above, the lack of immediate accessibility can have dangerous and life-threatening consequences.

Accordingly, it would be highly desirable to provide an improved method and apparatus for locating and accessing a safe used to store a loaded ready-to-use firearm. The implementation of a safe with self-illuminated points would allow the home or business owner to more easily locate the safe regardless of ambient light conditions.

Therefore, it is a principal object of the invention to provide an improved system and method for storing a firearm.

A further object of the invention is to provide an improved method and apparatus for safely storing a loaded ready-to-use firearm.

Another object of the invention is to provide an improved method and apparatus for locating a firearm storage unit in the dark.

Still a further object of the invention is to provide a self-contained firearm storage apparatus including a drawer method of storage for more flexible storage and use methods.

A further object of the invention is to provide a drawer storage using a motive force to slide the drawer from the closed to open position.

Still another object of the invention is to provide a firearm safe that can be located using tactile and visual methods.

Yet another object of the invention is to provide a firearm safe offering a lower height than most gun safes allowing it to stored under a bed or nightstand.

Still another object of the invention is to provide a firearm safe in varying lengths that can be stacked and organized in a secure modular fashion while maintaining all individual benefits.

### BRIEF DESCRIPTION OF THE DRAWINGS

FIG. 1 is a perspective illustration of the preferred embodiment of the modular rapid-access illuminated drawer safe with dual access methods therein constructed according to the principles of the present invention;

FIG. 2 is a perspective view of the present invention with the drawer compartment in the open position illustrating additional construction details and mode of operation thereof;

FIG. 3 is a side view of the present invention with the drawer compartment in the open position illustrating additional construction details and mode of operation thereof;

FIG. 4 is a perspective view of the present invention absent the drawer compartment illustrating additional construction details and mode of operation thereof;

FIG. 5 is a perspective view of the present invention absent the main housing illustrating additional construction details and mode of operation thereof;

FIG. 6 is a front view of the present invention as a cutaway exposing the locking mechanism, illustrating additional construction details and mode of operation thereof;

FIG. 7 is an expanded view of a section of the present invention, absent the main housing and drawer compartment, to further illustrate the control panel and accessibility features of the present invention or its variants as well as additional construction details and mode of operation thereof.

FIG. 8 is a perspective view of the present invention with the drawer compartment in the open position illustrating additional construction details and mode of operation thereof;

FIG. 9 is a top view of a variation of the present invention with the drawer compartment in the open position, illustrating an example of its storage abilities as well as additional construction details and mode of operation thereof;

FIG. 10 is a top view of a variation of the present invention with the drawer compartment in the open position, illustrating an example of its storage abilities as well as additional construction details and mode of operation thereof;

FIG. 11 is a top view of a variation of the present invention with the drawer compartment in the open position, illustrating an example of its storage abilities as well as additional construction details and mode of operation thereof;

FIG. 12 is an expanded view of a cross-section of the present invention to further illustrate the unique interlocking and securing features of the present invention when used alone or as components in a modular configuration as well as additional construction details and mode of operation thereof.

FIG. 13 is a front view of two preferred embodiments (one in plurality) of the present invention illustrating its stacking and storing ability when used as components in a modular configuration as well as additional construction details and mode of operation thereof;

FIG. 14 is a front view of three preferred embodiments of the present invention illustrating its stacking and storing ability when used as components in a modular configuration as well as additional construction details and mode of operation thereof and

FIG. 15 is a front view of three preferred embodiments (two in plurality) of the present invention illustrating its illustrating its stacking and storing ability when used as components in a modular configuration as well as additional construction details and mode of operation thereof.

### BRIEF SUMMARY OF THE PRESENT INVENTION

The present invention is a modular drawer safe possessing a rectangular shaped main housing with a rectangular opening accepting a drawer compartment secured to a self-powered slidable drawer assembly. The drawer compartment contains most of the operational components of the drawer safe, including control panel with all electronic components, storage elements and display screen, as well as the biometric access system featuring an illumination ring around the biometric reader providing constant low-level light, effectively aiding the user in quickly locating the drawer safe during low-light or no-light situations. Supplemental illumination lighting present at points at the upper sides of the interior of the drawer compartment further aids a user in the acquisition of firearms within the drawer compartment during low-light or no-light situations. The drawer compartment also contains the deadbolt system the drawer safe relies on to secure the drawer compartment within the main housing in a secure, yet quickly accessible manner.

The present invention is designed to allow flexibility dependent upon its manufactured length. One preferred embodiment of the present invention is manufactured of a size used to house smaller firearms such as handguns and revolvers, as well as valuables such as currency, jewelry or smaller items of value. Another variation of the present invention is manufactured of a size used to house medium-sized firearms such as tactical shotguns with additional ammunition as well as smaller firearms such as handguns and revolvers, as well as valuables such as currency, jewelry or small to medium-sized items of value. A third variation of the present invention is manufactured of a size used to house large-sized firearms such as long-guns, rifles, assault rifles and full-sized shot guns. Due to it's larger size it can also accommodate medium-sized firearms such as tactical shotguns with additional ammunition as well as smaller firearms such as handguns and revolvers, as well as valuables such as currency, jewelry or small to large-sized items of value. All variations of the present invention possess a plurality of upper indentions and lower protrusions from them main housing for use to secure to permanent surfaces or to secure as a component when used in a modular configuration. These indentions and protrusions are precisely sized and positioned in a manner to allow the varying sizes of drawer safes to fit together as explained herein. In this manner, a user can effectively stack a plurality of the drawer safes while maintaining an overall structural integrity and symmetry. Further, each individual component maintains its full accessibility and usability, separate from the other components.

### DETAILED DESCRIPTION OF THE PRESENT INVENTION

Reference is made to the illustrations of various components and features present in the preferred embodiments of the modular rapid-access illuminated drawer safe with dual access methods therein constructed according to the principles of the present invention.

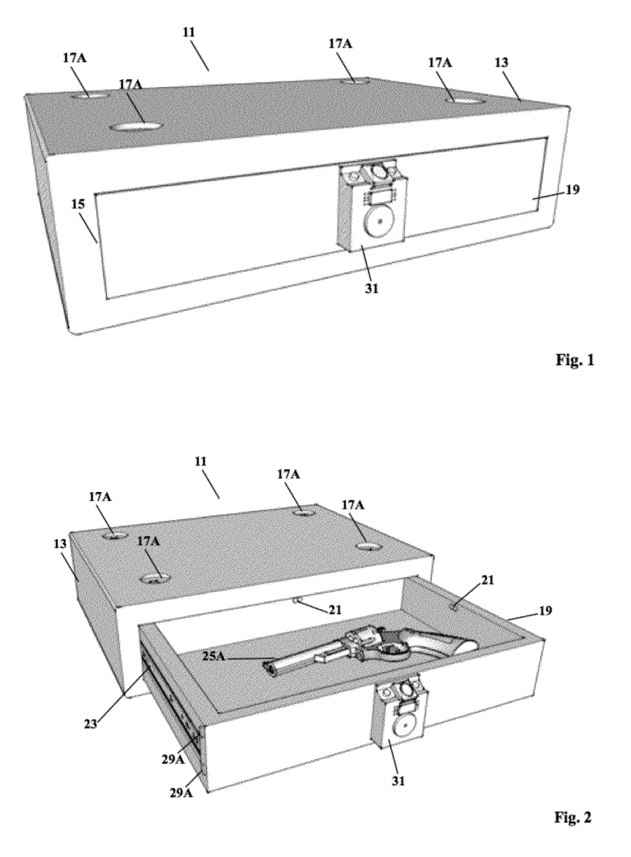

Referring now to the invention in more detail as shown in the illustrations provided, and in particular to FIGS. 1 thru 3, there is shown a modular drawer safe generally indicated by reference number 11 constructed of a main housing 13 composed of exterior sides (front, left, right, rear, top & bottom). The drawer safe 11 illustrated possesses a rectangular shape and is constructed of a durable metal or dense composite material much like most traditional safes currently manufactured. A rectangular opening 15 in the face of the front exterior side accepts a drawer compartment 19 secured to a self-powered slidable drawer assembly 23. Lower protrusions 17B in the bottom side of the main housing 13 act as the points of securing individual drawer safes 11 or as the male mating point 17B of the stacking and securing function when used in plurality as a modular configuration. Upper indentions 17A in the top side of the drawer safe act as the female mating point 17A of the stacking and securing function when used in plurality as a modular configuration.

The drawer compartment 19 is composed of the same durable materials used to fabricate the main housing 13 and contains most of the operational components of the drawer safe 11, including control panel 31 with all electronic components, storage elements and display screen 31D, as well as the biometric access system 31A featuring a multicolored illumination ring 31B around the biometric reader 31A providing constant low-level light, effectively aiding the user in quickly locating the drawer safe during low-light or no-light situations. Supplemental illumination lighting 21 present at points at the upper sides of the interior of the drawer compartment 19 further aids a user in the acquisition of firearms within the drawer compartment 19 during low-light or no-light situations. The drawer compartment 19 also contains the deadbolt system 19 the drawer safe 11 relies on to secure the drawer compartment 19 within the main housing 13 in a secure, yet quickly accessible manner.

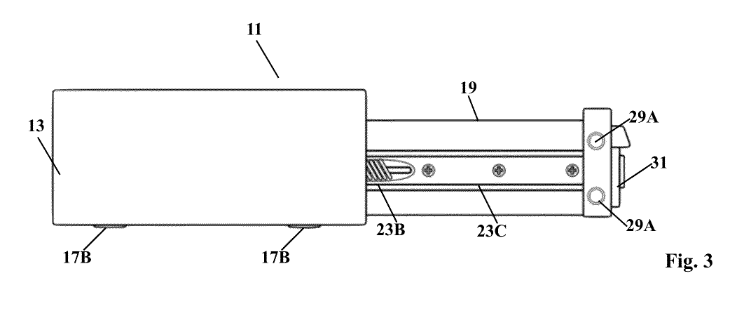

Referring to FIGS. 3 thru 5 for more detail on the drawer slide assembly 23. The fixed portion 23A of the drawer slide is mounted to the main housing 13 and contains a spring or pneumatically driven motive force 23B which acts to push the extension portion 23C of the drawer slide from the retracted to extended position. The extension portion 23C of the drawer slide assembly 23 is mounted to the drawer compartment 19. The fixed drawer slide 23A and the extension drawer slide 23C are designed to interlock, in a secure yet slide-able manner, thereby effectively joining the drawer compartment 19 to the main housing 13. Thus, the force originating from either a spring or pneumatic system 23B becomes the motive force which slides the drawer compartment 19 outward from the main housing 13 from the closed to open position.

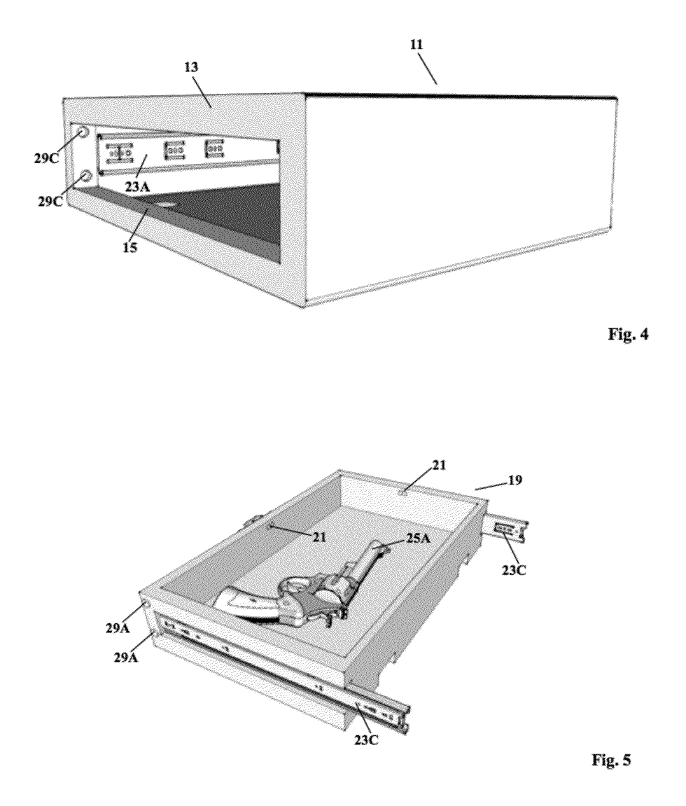

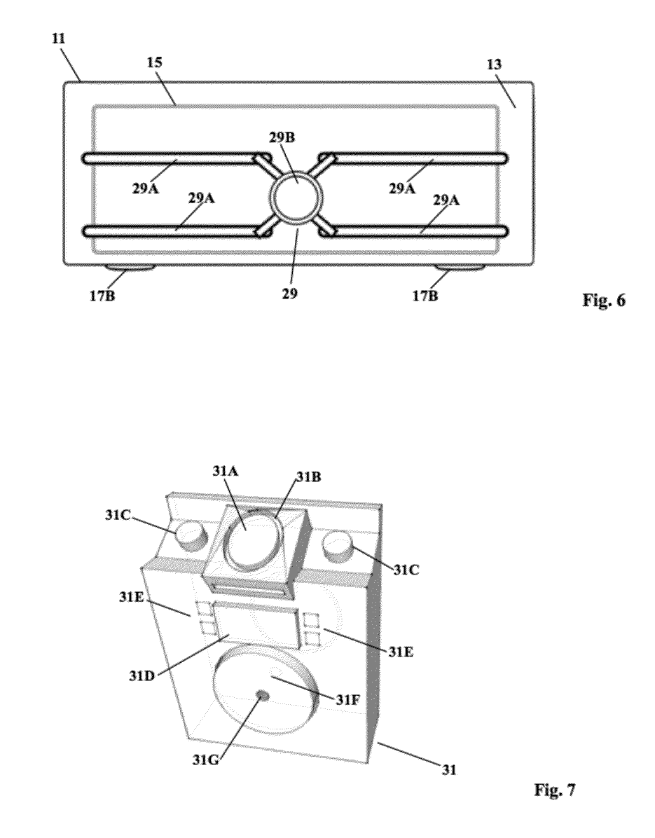

Referring to FIGS. 3, 4 & 6 for more detail on the deadbolt locking system 29. In this preferred embodiment, there are four deadbolt rods 29A, although the concept would equally apply to designs with fewer or greater deadbolt rods 29A. These deadbolt rods 29A are linked to a central locking mechanism 29B with an electrically powered solenoid unit 29B. The solenoid unit 29B is linked to the biometric reader 31A to receive a specific signal when an authorized user's fingerprint is scanned. When this occurs the proper signal is sent, triggering the solenoid 29B to retract the deadbolt rods 29A from the extended position. This action allows the drawer compartment 19 to slide outward of its own with motive force applied from the drawer assembly 23, to the open position. The drawer compartment 19 is closed manually by the user. As the drawer compartment 19 reaches the closed position, a switch is tripped, signaling the solenoid 29B to slide the deadbolt rods 29A from retracted position, outwards into the deadbolt receptor holes 29C of the main housing 13, thereby securing the drawer compartment 19 within the main housing 13, and preventing unauthorized access within.

If there is a complete power-failure or biometric, solenoid or system failure, an alternative access fail-safe is provided. The deadbolt locking system 29 has a traditional key lock 31G and manual knob turn system 31F. The user may insert a provided deadbolt key into the key hole 31G and turn the knob 31F to manually disengage the deadbolt rods 29A from the rod receptor holes 29C, in turn allowing the drawer compartment 19 to slide outward of its own motive force. If there is a power or solenoid 29B failure the user would manually turn the knob 31F on closing of the drawer compartment 19 to slide the deadbolt rods 29A from retracted position, outwards into the rod receptor holes 29C of the main housing 13, thereby securing the drawer compartment 19 within the main housing 13, and preventing unauthorized access within.

Reference is now made to FIGS. 2 & 5 for more detail on the supplemental illumination points 21 located in the upper sides of the interior of the drawer compartment 19 which further aid a user in the acquisition of firearms 25 within the drawer compartment 19 during low-light or no-light situations. In this preferred embodiment, there are four pairs of illumination points 21, although the concept would equally apply to designs with fewer or greater illumination points 21. Each illumination point 21 has two LED (or alternative low-energy lighting source) bulbs. One is a red low-level illumination bulb while the other is a brighter white illumination bulb. The low-level red bulbs are triggered on when the drawer compartment 19 slides from the closed to open position and provides enough lighting for the user to see the contents of the drawer compartment 19 without causing temporary-blindness in the darkness when ones eyesight has become accustomed to the lack of ambient lighting. Once in the open position, a user may switch on the brighter white illumination bulbs by way of lighting buttons 31C on the control panel 31 if more light is needed or desired.

Referring to FIG. 7 for more detail on the control panel 31. A control panel 31 is integrated within the face of the drawer compartment 19 and houses a biometric reader 31A capable of scanning, storing and matching as many as fifty (50) fingerprints. This biometric reader 31A is connected to a powered locking mechanism 29. An authorized user stores his fingerprint into the memory of the biometric reader 31A by scanning said fingerprint. This biometric data is stored internally within the control panel 31 for later comparison against any attempted access. When a user scans his finger it is compared with any previously scanned and authorized fingerprints. If an acceptable match is made the fingerprint scanner 31A will send a signal, by way of a circuit board, to the deadbolt solenoid 29B, thereby retracting the deadbolt securing rods 29A and allowing the drawer compartment 19 to slide into the open position.

A multicolored illumination ring 31B is situated around the biometric reader 31A. When the drawer safe 11 is not in use this low-level lighting glows with a soft blue hue. When there is little to no ambient lighting this illumination ring 31B acts as a beacon, guiding its user to the drawer safe 11 and the biometric reader 31A in a quick and efficient manner. If the user successfully scans an authorized fingerprint the illumination ring 31B provides a visual confirmation of access by changing from blue to green. This coincides with the disengaging of the deadbolt locking mechanism 29 as described previously. Alternatively, if a successful match is not made, the illumination ring 31B provides a visual denial of access by changing from blue to red. In a life-threatening situation this rapid visual feedback is crucial, allowing the user to try repositioning his finger or try another finger that had been previously scanned.

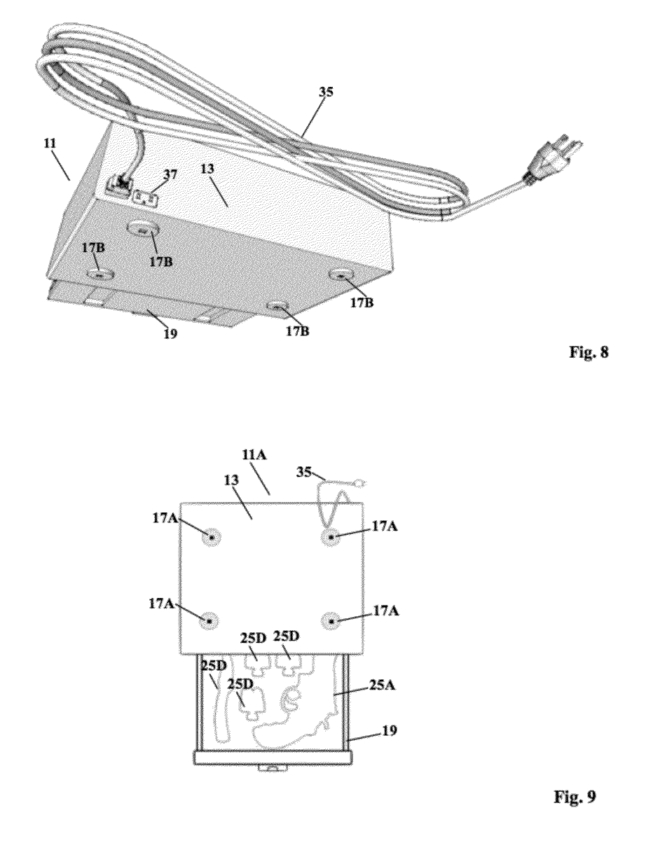

Reference is now made to FIG. 8 for more detail on the power source for the present invention. An internal rechargeable lithium-ion battery (33 not shown) is located in the control panel 31 and powers all control panel functions, the deadbolt locking system 29, multicolored illumination ring 31B and the supplemental illumination points 21. Line voltage (AC) by way of power cord 35 as brought in through the rear side of the main housing 13. This line voltage is converted to DC and provides a continuous trickle charge to the internal battery (33 not shown) ensures its constant state of full capacity for normal use and to ensure maximum duration of operational functionality if there is AC power 35 failure. When a plurality of drawer safes 11 are used as components in a modular configuration, a female plug access 37 located on the rear side of the main housing 13 allows all modular component safes to be daisy-chain connected, thus only requiring a single receptacle to provide power to all components.

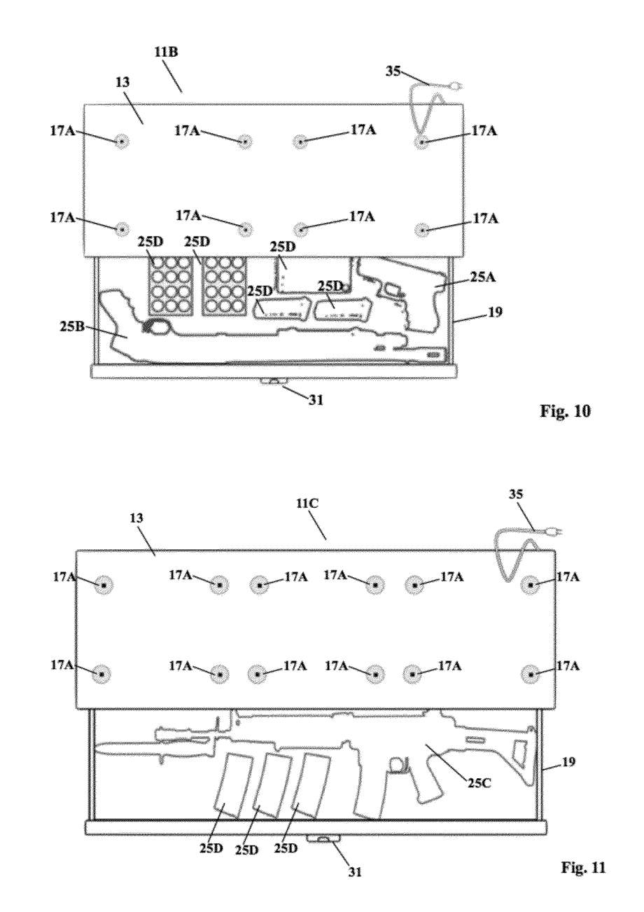

Reference is now made to FIGS. 9 thru 11 for more detail on the storage flexibility dependent upon the length of the main housing 13 and drawer compartments 19. FIG. 9 illustrates one preferred embodiment as a small drawer safe 11A manufactured of a size used to house smaller firearms 25 such as handguns and revolvers 25A, as well as valuables such as currency, jewelry or smaller items of value. As shown, the small drawer safe 11A possesses four (4) upper indentions 17A and four (4) lower protrusions 17B for use to secure to permanent surfaces or to secure as a component when used in a modular configuration. FIG. 10 illustrates one preferred embodiment as a medium drawer safe 11B manufactured of a size used to house medium-sized firearms such as tactical shotguns 25B with additional ammunition 25D as well as smaller firearms such as handguns and revolvers 25A, as well as valuables such as currency, jewelry or small to medium-sized items of value. As shown, this embodiment of drawer safe possesses eight (8) upper indentions 17A and eight (8) lower protrusions 17B for use to secure to permanent surfaces or to secure as a component when used in a modular configuration. These features 17A & 17B are sized and positioned in a manner to allow the varying sizes of drawer safes 11 to fit together as explained. FIG. 11 illustrates one preferred embodiment as a large drawer safe 11C manufactured of a size used to house large-sized firearms such as long-guns, rifles, assault rifles 25C and full-sized shot guns (25C not shown). Due to it's larger size it can also accommodate medium-sized firearms such as tactical shotguns 25B with additional ammunition 25D as well as smaller firearms such as handguns and revolvers 25A, as well as valuables such as currency, jewelry or small to large-sized items of value. As shown, this embodiment of drawer safe possesses twelve (12) upper indentions 17A and twelve (12) lower protrusions 17B for use to secure to permanent surfaces or to secure as a component when used in a modular configuration. These features 17A & 17B are sized and positioned in a manner to allow the varying sizes of drawer safes 11 to fit together as explained.

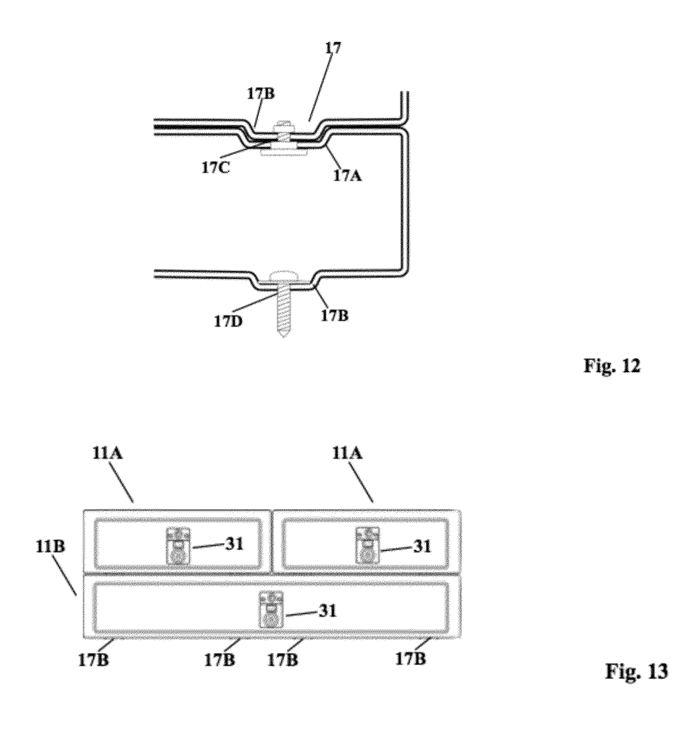

Reference is now made to FIG. 12 for more detail on the securing and modular stacking functionality 17 of the present invention. This cross section illustrates the right portion of one drawer safe 11 with the lower right portion illustrated of a second drawer safe 11 resting on top of the first. The lower protrusion 17B of the top unit fits within the upper indentation 17A of the lower unit. The bottom of the drawer safe 11 has a plurality of protrusions 17B each with a hole in its middle. When used as a single drawer safe 11 or as the base component in a modular configuration, these lower protrusions 17B are used to secure the drawer safe 11 to the floor or other permanent structure. The drawer safe 11 is properly secured using a lag screw or bolt 17D through the hole in the middle of the protrusion 17B, into the permanent structure. The composition and depth of the permanent structure will determine if a lag bolt or lag screw 17D is used. When the drawer safe 11 is to be an upper component in a modular configuration, the lower protrusion 17A acts as the male fitting that rests within the female upper indentation 17A located in the top side of the main housing 13 of a lower component in a modular system. An elevator bolt 17C is entered up through the upper indentation 17A of the bottom component and up through the lower protrusion 17B of the top component, being secured with a nut. In this manner, a user can effectively stack a plurality of the drawer safes 11 while maintaining an overall structural integrity and symmetry. Further, each individual component maintains its full accessibility and usability, separate from the other components.

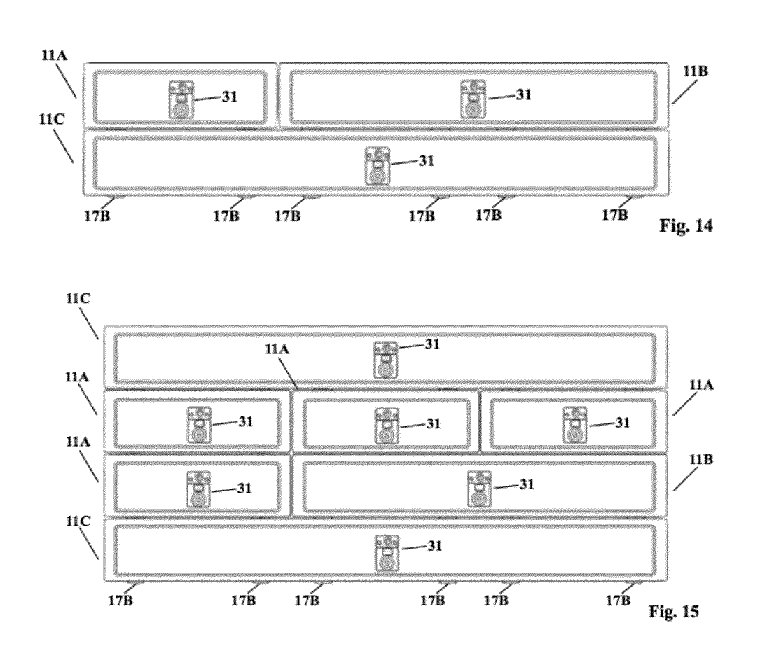

Referring to FIGS. 13 thru 15 for examples of a plurality of the present invention acting as components in a modular configuration. The preferred embodiments from FIGS. 9 thru 11 are used in these illustrations. FIG. 13 illustrates a combination of two (2) small drawer safes 11A (as shown in FIG. 9) and one (1) medium drawer safe 11B (as shown in FIG. 10). In such a configuration, the first tier is composed of one (1) medium drawer safe 11B which would be secured to the permanent structure. The second tier is composed of two (2) small drawer safes 11A secured side by side, to the first tier safe by joining the lower protrusion 17B of their main housing 13 to the upper indentations 17A of the medium safe main housing 11B. FIG. 14 illustrates a combination of one (1) small drawer safe 11A (as shown in FIG. 9), one (1) medium drawer safe 11B (as shown in FIG. 10), and one (1) large drawer safe 11C (as shown in FIG. 11). In such a configuration, the first tier is composed of one (1) large drawer safe 11C which would be secured to the permanent structure. The second tier is composed of one (1) small drawer safe 11A and one (1) medium drawer safe 11B secured side by side to the first tier safe by joining the lower protrusions 17B of their main housing 13 to the upper indentations 17A of the first tier safe main housing 13. FIG. 15 illustrates a combination of four (4) small drawer safes 11A (as shown in FIG. 9), one medium drawer safe 11B (as shown in FIG. 10), and two (2) large drawer safes 11C (as shown in FIG. 11). In such a configuration, the first tier is composed of one (1) large drawer safe 11C which would be secured to the permanent structure. The second tier is composed of one (1) small drawer safe 11A and one (1) medium drawer safe 11B secured side by side to the first tier safe by joining the lower protrusions 17B of their main housing 13 to the upper indentations 17A of the first tier safe 11. The third tier is composed of three (3) small drawer safes 11A, secured in a similar manner as previously described to the second tier drawer safes 11. The fourth tier is composed of one (1) large drawer safe 11C, secured in a similar manner as previously described to the third tier drawer safes 11.

The advantages of the present invention include, without limitation, that it is an improved method and apparatus for safely storing a loaded ready-to-use firearm. The implementation of a biometric locking mechanism preserves the security function of the safe while allowing the home or business owner immediate access with minimal motor skills and no cognitive memory requirements to gain access. The implementation of a drawer storage system in a horizontal manner allows more flexibility in sizing of the units as well as what contents can be successfully stored within the drawer compartment. The horizontal positioning also provides a very low overall height, thus allowing the present invention to be stored under a bed, nightstand or dresser and in proximity to the homeowner at night. When used in a home or business protection scenario, having a drawer compartment using a motive force to slide the drawer compartment outwards shortens the users response time from opening to possessing the ready-to-use firearm for defensive use. The implementation of an illumination ring around the biometric device ensure the user can quickly find the drawer safe and its opening mechanism even in no-light or low-light conditions. Further, the supplements illumination points within the drawer compartment ensure the user can quickly obtain the ready-to-use firearm therein. The ability of the present invention to be stacked and secured in plurality and in varying sizes in a modular configuration gives the user much expanded flexibility and usability.

While the foregoing written description of the present invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the present invention.

I claim:

1. A modular drawer safe unit for securing an item(s) of value and/or a firearm, being comprised of
(a) a rectangular shaped main housing formed by a bottom exterior surface, top exterior surface and four surrounding surfaces, with the front facing surround surface having a rectangular opening to accept a drawer compartment
(b) a drawer compartment formed by four surround surfaces and a bottom surface mounted in a slidable manner within the main housing creating an area for placement of items of value and/or a firearm
(c) a deadbolt locking mechanism built within the front face of the drawer compartment with deadbolts which can extend outwards into the main housing, thus joining the drawer compartment within the main housing in a secure manner
(d) a control panel within to the front face of the drawer compartment containing biometric sensor and electronic components to control the operation of identifying users and triggering the engaging and disengaging of the deadbolt assembly, and
(e) a method of conveying electrical power to the control panel and all electrical components within the drawer compartment

2. The drawer safe of claim 1, wherein the manufactured size is suitable to house smaller firearms such as handguns and revolvers, as well as valuables such as currency, jewelry or smaller items of value.

3. The drawer safe of claim 1, wherein the manufactured size is suitable to house medium-sized firearms such as tactical shotguns with additional ammunition as well as smaller firearms such as handguns and revolvers as well as valuables such as currency, jewelry or small to medium-sized items of value.

4. The drawer safe of claim 1, wherein the manufactured size is suitable to house large-sized firearms such as long-guns, rifles, assault rifles and full-sized shot guns as well as medium-sized firearms such as tactical shotguns and smaller firearms such as handguns and revolvers, as well as valuables such as currency, jewelry or small to large-sized items of value.

5. The drawer safes of claims 2, 3 & 4, may be mounted and secured when used in plurality in a modular fashion to the other by way of
(a) the bottom side of the main housing possessing lower protrusions which serve to function as the points of securing individual drawer safes to a permanent structure or as the male mating point of the stacking and securing function when used in plurality as a modular configuration by resting within the
(b) female upper indentations located in the top side of the main housing which serve to function as the female mating point of the stacking and securing function when used in plurality as a modular configuration, and
(c) these lower protrusions and upper indentations are sized and position, regardless of drawer unit size, to allow a plurality of the drawer safes to be stacked and properly secured using an elevator bolt entered up through the upper indentation of the bottom component and up through the lower protrusion of the top component, being secured with a nut thereby maintaining overall structural integrity and the full accessibility of each individual drawer safe in the modular configuration.

6. The drawer safe of claim 1, wherein the drawer slide assembly contains a spring or pneumatically driven motive force which acts to push the extension portion of the drawer slide from the retracted to extended position.

7. The drawer safe of claim 1, wherein the primary deadbolt lock disengaging/re-engaging system is comprised of deadbolts linked to an electronic solenoid to engage and retract the deadbolt locking mechanism

8. The drawer safe of claim 1, wherein the supplementary locking system deadbolt lock disengaging/re-engaging system is comprised of a traditional keyed lock and manual knob turn system to manually disengage or re-engage the deadbolt rods from the rod receptor holes

9. The drawer safe of claim 1, wherein the biometric reader features a multicolored illumination source that serves as a visual reference through three distinct visual conditions including
(a) a standby status visually referenced with blue light illumination, when the drawer safe is not in use, which serves as a point of visual reference, guiding its user toward the drawer safe and the biometric reader when there is little or no ambient lighting, and
(b) a positive biometric read status visually referenced with a change to green light illumination triggered when a user successfully scans an authorized fingerprint thereby providing a visual confirmation of access by changing from status blue to positive green and occurring with the disengaging of the deadbolt locking mechanism, and
(c) a negative biometric read status visually referenced with a change to red light illumination if a successful biometric match is not made thereby providing a visual denial of access by changing from status blue to negative red.

10. The drawer safe of claim 1, wherein supplemental illumination lighting exists in one or more locations within the interior of the drawer compartment comprised of
(a) low-level illumination that turns on automatically when the drawer compartment slides from the closed to open position, and
(b) full illumination which can be turned on manually by the user via a switch or button control

11. The drawer safe of claim 1, wherein primary power to all electrical components is provided by continuous AC power received through an AC plug in the rear of the drawer safe and connected by electrical power cord to an electrical outlet.

12. The drawer safe of claim 11, wherein a supplementary power to all electrical components is provided by a back-up rechargeable battery.

13. The drawer safe of claim 11, wherein the back-up rechargeable battery receives a trickle charge while connected to AC power to maintain a full charge while not being used to power the electrical components of the drawer safe.

14. The drawer safe of claim 11, wherein a second female AC plug is featured beside the primary AC plug which serves to allow a plurality of drawer safes to interconnect between each unit with only one drawer safe requiring a single receptacle to provide AC power to all drawer safes used in the modular configuration
